(19) United States
(12) Patent Application Publication
(10) Pub. No.: US 2020/0224408 A1
(43) Pub. Date: Jul. 16, 2020

(54) CLIP

(71) Applicant: SEKURE LOK PTY LTD, New South Wales (AU)

(72) Inventor: Philip THRIFT, Yellow Rock (AU)

(21) Appl. No.: 16/647,745

(22) PCT Filed: Sep. 26, 2017
(86) PCT No.: PCT/AU2017/051050

§ 371 Date: Mar. 16, 2020

(51) Int. Cl. E04B 1/41; F16B 2/06; F16B 5/12; E04B 1/04

(52) U.S. Cl. CPC E04B 1/40; E04B 1/043; F16B 5/123; F16B 2/065

(57) ABSTRACT

Embodiments generally relate to clips for fastening members together using friction connections, as well as kits and structures comprising such clips, and methods of construction involving such clips. Some embodiments relate to panel clips to assist in fastening panels to frames. For example, in some embodiments, a clip may comprise a plate defining a frame engaging portion and panel engaging portion. The clip may be fastened to the panel with a bolt, and the frame engaging portion urged against a flange of a frame element to form a friction connection. One or more projecting portions may extend away from the plate to engage the frame element and restrict rotation of the clip relative to the frame once installed.

### TECHNICAL FIELD

Embodiments generally relate to clips for fastening members together using friction connections. Some embodiments relate to panel clips to assist in fastening panels to frames.

### BACKGROUND

There a number of different clips used in different applications for mechanically fastening members together, such as railway clips for fastening the rails of a railway line to the sleepers, and panel clips for fastening panels to frames, for example, fastening a pre-cast concrete panel to a flange of a steel column.

Some panel clips are fastened to panels by mechanical fastening with a bolt, for example, and welded to a steel frame element, such as a column. However, once installed, relative movement between the panel and steel frame (which may be caused by differential thermal expansion and/or contraction, for example) may cause the welded joins to crack and separate the panel clips from the frame.

Other panel clips are fastened to the frame with a friction connection, wherein as the bolt is tightened to fasten the clip to the panel, a surface of the clip is urged against a flange of a steel column (sandwiched between the panel and the clip) to form a friction connection. However, in some cases, the clip may rotate during or after tightening of the bolt to move the clip out of contact with the frame or reduce the effectiveness of the friction connection.

This problem has previously been addressed by forming a panel clip with a projecting tooth configured to engage a complimentary recess formed in the panel to restrict rotation of the panel clip relative to the panel (see co-owned Australian Patent Number 2007336698).

It is desired to address one or more shortcomings or disadvantages associated with existing clips, or panel clips, or to at least provide a useful alternative.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### SUMMARY

Some embodiments relate to a clip to assist in fastening first and second members to each other, the clip comprising:

a plate defining:
a first engaging portion at a first end of the plate for engaging the first member;
a second engaging portion at a second end of the plate opposite the first end for engaging the second member; and
a fastener aperture located between the first engaging portion and the second engaging portion, the fastener aperture being configured to receive a fastener to connect the clip to the second member; and

one or more projecting portions extending away from the plate at or near the first engaging portion between the first and second ends of the plate;

wherein the clip is configured to be connected to the second member, by the fastener, such that the second engaging portion is urged against the second member and the first engaging portion is urged against the first member to form a friction connection between the first engaging portion and the first member, and

wherein the one or more projecting portions are configured to restrict rotation of the clip, once installed, by abutting part of the first member.

In some embodiments, the first engaging portion may define a flat contact surface for contacting a flat surface of the first member. The first engaging portion may be configured to engage a flange of the first member. The first engaging portion may be configured to engage part of a frame. For example, the first engaging portion may be configured to engage a flange of a frame element, such as a beam or column.

The second engaging portion may be configured to engage part of a panel, such as a pre-cast concrete panel, for example. The clip may be configured to assist in fastening a panel to a frame. The clip may comprise a panel clip.

In some embodiments, a plane of the second engaging portion may extend away from a plane of the first engaging portion at an obtuse angle. An edge of the second engaging portion may be configured to engage the second member.

In some embodiments, the one or more projecting portions may comprise an elongate ridge extending alongside at least part of the first engaging portion of the plate.

In some embodiments, the fastener aperture may be defined by an elongate slot. In some embodiments, the clip may further define a washer slot alongside the fastener aperture, the washer slot being configured to receive part of a swageable washer to restrict rotation of the fastener relative to the clip once installed.

Some embodiments relate to a structure comprising one or more of the clips.

Some embodiments relate to a kit comprising one or more of the clips.

In some embodiments, the kit may comprise one or more of the clips and a swageable washer, the washer comprising a washer body configured to engage the clip and a swageable cap configured to engage the fastener to restrict relative rotation between the fastener and the clip. In some embodiments, the kit may further comprise the fastener.

Some embodiments relate to a method of construction comprising fastening one of the clips to a second member in order to assist in fastening the second member to a first member. For example, the first member may comprise a frame or frame element, and the second member may comprise a panel.

In some embodiments, fastening the clip to the second member may comprise passing a threaded end of a bolt through the fastener aperture and rotating the bolt to engage the second member and fasten the clip to the second member. The second member may comprise a female threaded portion configured to receive and threadedly engage the threaded end of the bolt. The female threaded portion may be defined by a nut or threaded ferrule connected to or cast into the second member.

In some embodiments, the method may further comprise: locating a swageable washer between a head of the bolt and the clip before fastening the clip to the second member; and swaging the washer to restrict rotation of the bolt after fastening the clip to the second member.

### BRIEF DESCRIPTION OF DRAWINGS

Exemplary embodiments will now be described in relation to the drawings, in which:

FIG. 1 shows a perspective view of a clip, according to some embodiments;

FIG. 2 shows an exploded diagram illustrating installation of the clip of FIG. 1 to assist in fastening first and second members to each other, according to some embodiments;

FIG. 3 shows a cross-sectional view of the clip of FIG. 1 installed and fastening the first and second members of FIG. 2 to each other;

FIG. 4A shows a plan view of a clip according to some embodiments;

FIG. 4B shows a side view of the clip of FIG. 4A.

### DESCRIPTION OF EMBODIMENTS

Embodiments generally relate to clips for fastening members together using friction connections. Some embodiments relate to panel clips to assist in fastening panels to frames.

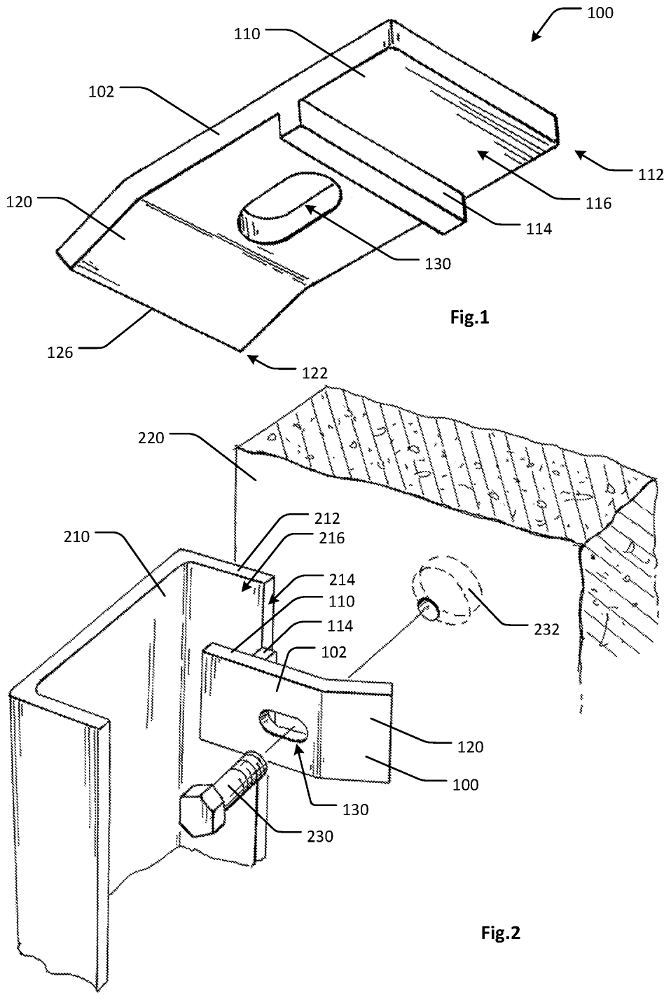

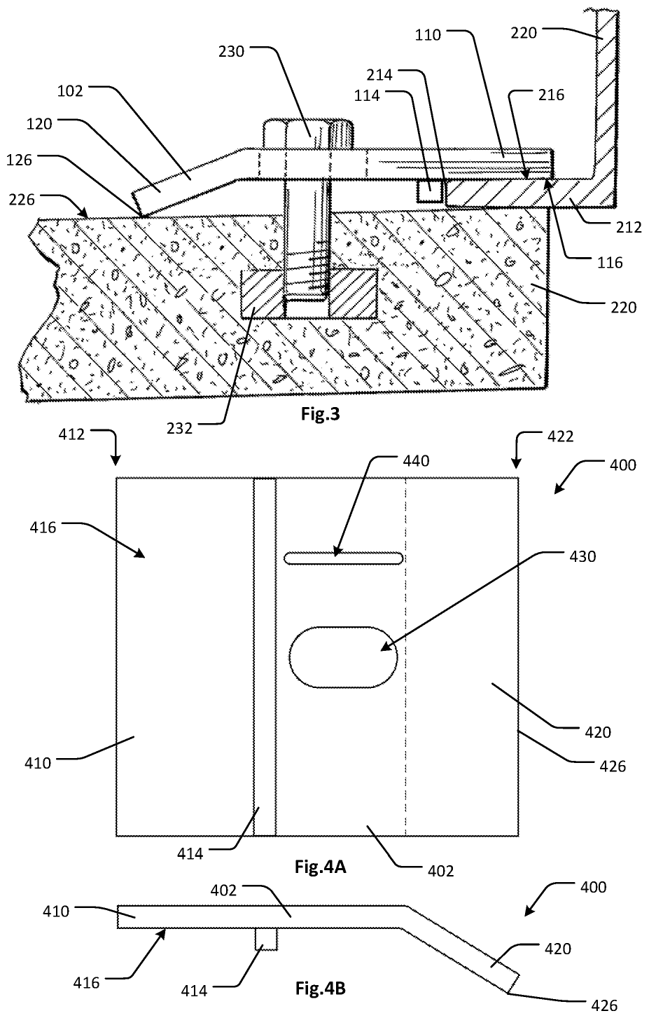

Referring to FIG. 1, a clip 100 is shown according to some embodiments. The clip 100 may be used to assist in fastening first and second members to each other. For example, referring to FIGS. 2 and 3, in some applications the first member 210 may comprise an element of a frame and the second member 220 may comprise a panel.

The clip 100 comprises a plate 102 defining a first engaging portion 110 at a first end 112 of the plate 102 for engaging the first member 210 and a second engaging portion 120 at a second end 122 of the plate 102 opposite the first end 112 for engaging the second member 220. The plate 102 may further define a fastener aperture 130 located between the first engaging portion 110 and the second engaging portion 120.

The fastener aperture 130 may be configured to receive a fastener 230 to connect the clip 100 to the second member 220. For example, referring to FIGS. 2 and 3, in some applications, a mechanical fastener 230, such as a screw or bolt, may be used to connect the clip 100 to the second member 220.

The clip 100 is configured to be connected to the second member 220, by the fastener 230, such that the second engaging portion 120 is urged against the second member 220 and the first engaging portion 110 is urged against the first member 210 to form a friction connection between the first engaging portion 110 and the first member 210.

The clip 100 may comprise one or more projecting portions 114 extending away from the plate 102 at or near the first engaging portion 110 between the first and second ends 112, 122 of the plate 102. The one or more projecting portions 114 are configured to restrict rotation of the clip 100, once installed, by abutting part of the first member 210.

In some embodiments, the fastener aperture 130 may be defined by an elongate slot, as shown in FIG. 1. That is, the aperture 130 may be longest in one direction. A maximum diameter of the aperture 130 may be aligned along the plate 102 with an axis extending between the first and second engaging portions 110, 120. This may allow for small relative movements between the first and second members 210, 220 by allowing the fastener 230 to move along the length of the fastener aperture 130 without compromising the connection between the clip 100 and the first and second members 210, 220.

In some embodiments, the first engaging portion 110 may be configured to engage a flange 212 of the first member 210. For example, referring to FIGS. 2 and 3, the clip 100 may comprise a panel clip 100 configured to assist in fastening a panel 220 to a frame element 210.

The frame element 210 may comprise a steel column having a flange 212 (such as the flange of an I-section profile, for example), and the clip 100 may be configured such that, once installed, a contact surface 116 of the first engaging portion 110 contacts a contact surface 216 of the flange 212. As the fastener 230 is tightened to connect the clip 100 to the panel 220, the second engaging portion 120 is urged against a contact surface 226 of the panel 220 and the first engaging portion 110 is urged against the flange 212 of the frame element 210, such that a friction connection is formed between the respective contacting surfaces 116, 216 of the first engaging portion 110 and the flange 212 of the frame element 210.

In some applications, a plane of the contact surface 226 of the second member or panel 220 may be offset from a plane of the contact surface 216 of the first member or frame element 210. For example, in FIG. 3, the offset distance between the levels of the contact surfaces 216, 226 corresponds to the thickness of the flange 212 which directly abuts the flat contact surface 226 of the panel 220.

To account for the difference in the levels of the contact surfaces 216, 226, in some embodiments, the second engaging portion 120 of the plate 102 may be angled relative to the rest of the plate 102, as shown in FIG. 1. For example, a plane of the second engaging portion 120 may extend away from a plane of the first engaging portion 110 at an obtuse angle. A contact edge 126 of the second engaging portion 120 may be configured to engage the contact surface 226 the second member 220.

The angle between the planes of the first and second engaging portions 110, 120 may be configured such that, when the clip 100 is installed with the edge 126 of the second engaging portion 120 engaging the contact surface 226 of the second member or panel 220 the respective contact surfaces 116, 216 of the first engaging portion 110 and first member 210 contact each other in a substantially parallel configuration.

In some embodiments, the second engaging portion 120 may lie in the same plane as the rest of the plate 102 and may not be angled with respect to the first engaging portion 110. This configuration may be used in applications where the contact surfaces of the first and second members 210, 220 are level. For example, with a panel having an edge rebate to accommodate the flange of a frame element, such that respective contact surfaces of the flange and the panel are level.

Referring again to FIGS. 2 and 3, the one or more projecting portions 114 may be configured to abut an edge 214 of the flange 212 of the frame element 210, once installed, to restrict rotation of the clip 100 relative to the frame element 210. The one or more projecting portions 114 may extend away from the plate 102 by a distance that is less than the thickness of the flange 212 so that the one or more projecting portions do not contact the panel 220 and potentially restrict contact between the respective contact surfaces 116, 216 of the first engaging portion 110 and the flange 212.

The one or more projecting portions 114 may extend away from a surface of the plate 102 adjacent the contact surface 116. The one or more projecting portions 114 may be arranged or oriented along a line adjacent the contact surface 116. The line of orientation may be substantially parallel to an edge of first end 112 of the plate 102. The line of orientation may be substantially perpendicular to a central axis of the plate 102 extending between the first and second engaging portions 110, 120. In some embodiments, the one or more projecting portions 114 may comprise an elongate ridge extending alongside at least part of the first engaging portion 110 of the plate 102, as shown in FIG. 1. In some embodiments, the one or more projecting portions 114 may comprise two or more projecting portions 114 spaced apart from one another at or near the first engaging portion 110.

The panel 220 may comprise a cast-in nut or ferrule 232 configured to receive and engage the fastener or bolt 230 to connect the clip 100 to the panel 220. In some applications, the fastener 230 may engage a drilled in anchor in the panel 220, or may engage the material of the panel 220 (e.g., concrete) directly.

The clip 100 may be formed of any suitable material with sufficient strength and stiffness to transfer forces between the fastener 230 and the first and second members 210, 220 to provide a friction connection of sufficient strength for a given application. Some suitable materials may include metals, metal alloys, steel, structural steel, G250 grade structural steel or G350 grade structural steel, for example.

The clip 100 may be formed from a plate by cutting, stamping, milling or drilling the fastener aperture 130; folding, deflecting or bending the second engaging portion 120 away from the plane of the first engaging portion 110 at an angle (this process may be omitted for flat plate embodiments); and forming the one or more projecting portions 114. In some embodiments, the one or more projecting portions 114 may be formed by making cuts in the plate 102 and bending part of the plate 102 away from the plane of the first engaging portion 110 to form the projecting portions 114. In some embodiments, the one or more projecting portions 114 may be formed separately and then fixed to the plate 102 at or near the first engaging portion 110, such as by welding, for example.

In embodiments where the one or more projecting portions 114 comprise an elongate ridge (as shown in FIG. 1, for example), the ridge may be formed as a strip having a rectangular or square profile and welded to the plate 102, for example.

The clip 100 may be formed with different dimensions for different applications. For example, the clip 100 may be approximately 150 mm long from the first end 112 to the second end 122 and approximately 130 mm wide. The thickness of the plate 102 may be approximately 8 mm. The fastener aperture 130 may be approximately 40 mm long and 22 mm wide. The one or more projecting portions 114 may extend away from the plate 102 by a distance of about 8 mm. The angle between the plane of the first engaging portion 110 and the plane of the second engaging portion 120 may be approximately 30°. The difference in the respective levels of the contact surface 116 of the first engaging portion 110 and the contact edge 126 of the second engaging portion 120 may be approximately 17 mm. The first engaging portion 110 may be approximately 50 mm long and approximately 130 mm wide.

These dimensions are given as an example only, and the dimensions, and relative proportions may vary significantly in different embodiments, such as different clips for different applications. For example, the length and width of the clip 100 may be varied to accommodate differently dimensioned contact surfaces 216 on different first members 210, or to adjust the degree of leverage between the fastener 230 and the first and second engaging portions 110, 120. The plate thickness may be increased or decreased depending on the strength and stiffness required for a given application. The dimensions of the fastener aperture 130 may be adjusted to accommodate different fasteners 230. The distance that the one or projecting portions 114 extend away from the plate 102 may be adjusted depending on the contact area required between the one or more projecting portions 114 and the first member 210. The angle between the plane of the first engaging portion 110 and the plane of the second engaging portion 120 and/or the difference in the respective levels of the contact surface 116 of the first engaging portion 110 and the contact edge 126 of the second engaging portion 120 may be varied depending on the difference in the respective levels of the contact surfaces 216, 226 of the first and second members 210, 220.

For example, in some embodiments, the clip 100 may be between 100 mm and 300 mm long from the first end 112 to the second end 122 and between 50 mm and 200 mm wide. The thickness of the plate 102 may be between 3 mm and 20 mm, or between 5 mm and 10 mm. The fastener aperture 130 may be between 20 mm and 100 mm long and between 10 mm and 50 mm wide. The one or more projecting portions 114 may extend away from the plate 102 by a distance of between 2 mm and 20 mm, or between 5 mm and 10 mm. The angle between the plane of the first engaging portion 110 and the plane of the second engaging portion 120 may be between 0° and 90°, between 10° and 60°, or between 20° and 45°. The difference in the respective levels of the contact surface 116 of the first engaging portion 110 and the contact edge 126 of the second engaging portion 120 may be between 0 mm and 50 mm, between 5 mm and 30 mm, or between 10 mm and 20 mm. The first engaging portion 110 may be between 10 mm and 100 mm long and between 50 mm and 200 mm wide.

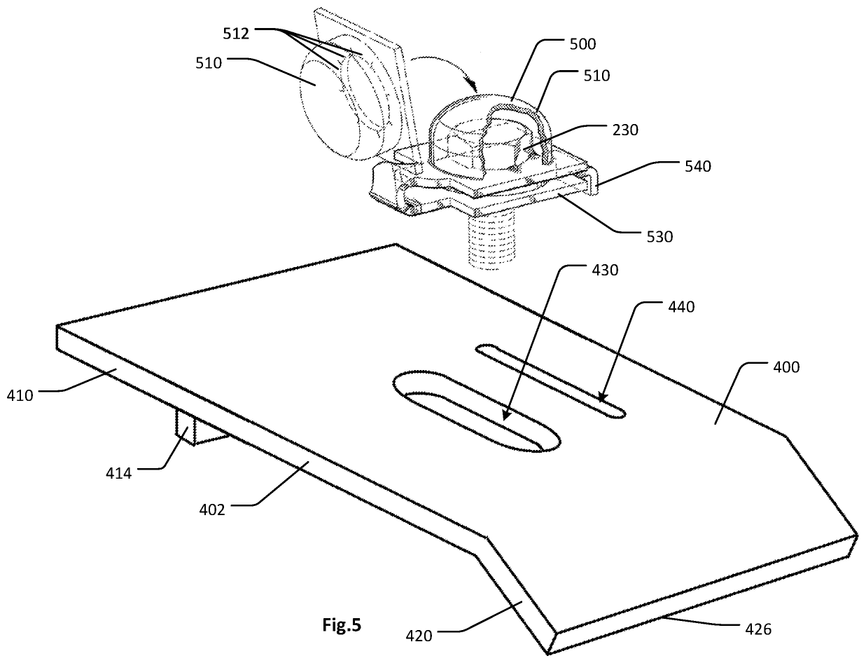

Referring to FIGS. 4A and 4B, a clip 400 is shown according to some embodiments. The clip 400 may have similar features to those described in relation to clip 100 and similar features are indicated with similar reference numerals. The clip 400 may be formed in a similar manner with similar suitable materials as described in relation to clip 100.

The clip 400 comprises a plate 402 defining a first engaging portion 410 at a first end 412 of the plate 402 for engaging the first member 210 and a second engaging portion 420 at a second end 422 of the plate 402 opposite the first end 412 for engaging the second member 220. The plate 402 further defines a fastener aperture 430 located between the first engaging portion 410 and the second engaging portion 420. The fastener aperture 430 is be configured to receive a fastener 230 to connect the clip 400 to the second member 220.

The clip 400 is configured to be connected to the second member 220, by the fastener 230, such that the second engaging portion 420 is urged against the second member 220 and the first engaging portion 410 is urged against the first member 210 to form a friction connection between the first engaging portion 410 and the first member 210.

The clip 400 comprises one or more projecting portions 414 extending away from the plate 402 at or near the first engaging portion 410 between the first and second ends 412, 422 of the plate 402. The one or more projecting portions 414 are configured to restrict rotation of the clip 400, once installed, by abutting part of the first member 210.

The clip 400 further defines a washer slot 440 alongside the fastener aperture 430. The washer slot 440 is configured to receive part of a swageable washer 500 to restrict rotation of the fastener 230 relative to the clip 400 once installed. For example, one such swageable washer is described in Australian Patent Number 2006294407 (International Application PCT/AU2006/001371), the disclosure of which is hereby incorporated by reference.

Referring to FIG. 5, in some embodiments, the swageable washer 500 comprises a main washer body 530 defining an aperture (not shown) for the fastener or bolt 230 to pass through, and a cap 510 configured to cover a head of the bolt 230 to restrict rotation of the bolt 230. The cap 510 comprises a plurality of swageable tabs 512 arranged in an annular formation around an opening of the cap 510. The swageable tabs 512 are configured to be deformed by the bolt head when the cap 510 is forced down over the bolt head, thereby cooperating to engage and restrict rotation of the bolt 230 relative to the washer 500. The washer 500 further comprises a tab 540 extending from the body 530 of the washer 500, which is configured to engage part of the clip 100, 400 to restrict relative rotation between the washer 500 and the clip 100, 400.

In some embodiments, the tab 540 of the washer 530 may engage an edge of the clip 100, 400. In some embodiments, in which the clip 400 defines a washer slot 440, the tab 540 of the washer 500 may engage the washer slot 440. For example, the washer slot 440 may receive at least part of the tab 530 of the washer 500, and edges of the washer slot 440 may restrict rotation of the washer tab 530, and washer 500, relative to the clip 400.

In some embodiments, the clip 100, 400 may be supplied with the swageable washer 500. In some embodiments, the clip 100, 400 and washer 500 may also be supplied with a fastener 230.

The described clips 100, 400 may have many different applications in fastening a first member 210 to a second member 220. Some examples include fastening rail way tracks to sleepers, fastening frame elements to foundations, fastening steel frame elements (such as columns or beams) to a concrete slab, fastening a bracket or other member to a panel (such as a concrete panel), or fastening a panel to a frame element.

As described in relation to FIGS. 2 and 3, the described clips 100, 400 may be used to assist in fastening a concrete panel to a steel column, for example.

A structure (such as a commercial or residential building or warehouse) may be constructed by erecting a steel frame on a concrete slab, and then fastening a plurality of pre-cast concrete panels to the steel frame. Each panel 220 may be placed against columns 210 of the frame, and then fastened to the columns 210 using the clips 100, 400.

For example, a threaded end of a fastener or bolt 230 may be passed through the fastener aperture 130, 430 and rotated to engage the panel 220 and fasten the clip 100, 400 to the panel 220. As the bolt 230 is tightened, the second engaging portion 120, 420 is urged against the panel 220, and the first engaging portion 110,410 is urged against the flange 212 of the column 210. The clip 100, 400 then acts as a lever between the bolt 230, panel 220 and column 210, forming a friction connection between the first engaging portion 110, 410 of the clip 100, 400 and the flange 212 of the column 210.

In some embodiments, the bolt 230 may be driven directly into the panel 220, or into a predrilled hole in the panel 220 to directly engage the material of the panel 220. In some embodiments, the panel 220 may comprise a cast-in nut or ferrule to engage the bolt 230, or the panel 220 may define a through-hole for the threaded end of the bolt 230 to pass through and engage with a nut on an opposite side of the panel 220.

In some embodiments, the swageable washer 500 may be used to restrict rotation of the bolt 230 once the clip 100, 400 has been installed. The swageable washer 500 may be located between a head of the bolt 230 and the clip 100, 400 before fastening the clip 100, 400 to the panel 220. The washer 500 may then be swaged onto the bolt head to restrict rotation of the bolt 230 after fastening the clip 100, 400 to the panel 220.

As described previously, some structures have been erected in the past using panel clips that are bolted to the panel and welded to the frame. These welded joints often crack and fail due to relative movement between the panel and the frame due to vibration or thermal expansion and contraction. In such cases, the described panel clips 100, 400 of the present disclosure may be installed in existing structures to replace or complement existing panel clips (or other fasteners or connectors). This may enhance or improve the strength and/or durability of the connections between panels and frames.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A clip to assist in fastening first and second members to each other, the clip comprising:
a plate defining:
a first engaging portion at a first end of the plate for engaging the first member;
a second engaging portion at a second end of the plate opposite the first end for engaging the second member;
a fastener aperture located between the first engaging portion and the second engaging portion, the fastener aperture being configured to receive a fastener to connect the clip to the second member; and
a washer slot alongside the fastener aperture, the washer slot being configured to receive part of a swageable washer to restrict rotation of the fastener relative to the clip once installed; and
one or more projecting portions extending away from the plate at or near the first engaging portion between the first and second ends of the plate;
wherein the clip is configured to be connected to the second member, by the fastener, such that the second engaging portion is urged against the second member and the first engaging portion is urged against the first member to form a friction connection between the first engaging portion and the first member, and
wherein the one or more projecting portions are configured to restrict rotation of the clip, once installed, by abutting part of the first member.

2. A clip according to claim 1, wherein the first engaging portion is configured to engage a flange of the first member.

3. A clip according to claim 1, wherein the second engaging portion is configured to engage part of a panel; the first engaging portion is configured to engage part of a frame; and the clip is configured to assist in fastening the panel to the frame.

4. A clip according to claim 1, wherein the fastener aperture is defined by an elongate slot.

5. A clip according to claim 1, wherein a plane of the second engaging portion extends away from a plane of the first engaging portion at an obtuse angle.

6. A clip according to claim 1, wherein the first engaging portion defines a flat contact surface for contacting a flat surface of the first member.

7. A clip according to claim 1, wherein an edge of the second engaging portion is configured to engage the second member.

8. A clip according to claim 1, wherein the one or more projecting portions comprise an elongate ridge extending alongside at least part of the first engaging portion of the plate.

9. (canceled)

10. A structure comprising one or more clips according to claim 1.

11. A method of construction comprising fastening a clip according to claim 1 to a second member in order to assist in fastening the second member to a first member.

12. A method of construction according to claim 11, wherein fastening the clip to the second member comprises passing a threaded end of a bolt through the fastener aperture and rotating the bolt to engage the second member and fasten the clip to the second member.

13. A method of construction according to claim 12, wherein the second member comprises a female threaded portion configured to receive and threadedly engage the threaded end of the bolt.

14. A method of construction according to claim 12, further comprising:
locating a swageable washer between a head of the bolt and the clip before fastening the clip to the second member; and
swaging the washer to restrict rotation of the bolt after fastening the clip to the second member.

15. A method of construction according to claim 11, wherein the first member comprises a frame and the second member comprises a panel.

16. A kit comprising:
a clip according to claim 1; and
a swageable washer, the washer comprising a washer body configured to engage the clip and a swageable cap configured to engage the fastener to restrict relative rotation between the fastener and the clip.

17. A kit according to claim 16, further comprising a fastener.

18. (canceled)

19. A clip according to claim 4, wherein a plane of the second engaging portion extends away from a plane of the first engaging portion at an obtuse angle.

20. A clip according to claim 5, wherein the one or more projecting portions comprise an elongate ridge extending alongside at least part of the first engaging portion of the plate.

21. A clip according to claim 19, wherein the one or more projecting portions comprise an elongate ridge extending alongside at least part of the first engaging portion of the plate.

22. A structure according to claim 10, further comprising a plurality of pre-cast concrete panels fastened to columns of a steel frame with the one or more clips.
